(19) United States
(12) Patent Application Publication
(10) Pub. No.: US 2026/0103155 A1
(43) Pub. Date: Apr. 16, 2026

(54) COMMUNICATION SYSTEM

(71) Applicant: DENSO CORPORATION, Kariya-city (JP)

(72) Inventors: Yoji HOMMA, Kariya-city (JP); Akira TADA, Kariya-city (JP); Tomoya TOKUNAGA, Kariya-city (JP)

(21) Appl. No.: 19/354,885

(22) Filed: Oct. 10, 2025

(30) Foreign Application Priority Data
Oct. 15, 2024 (JP) 2024-179771

(51) Int. Cl. B60R 16/023; H04L 41/0631

(52) U.S. Cl. CPC B60R 16/0238; H04L 41/0631

(57) ABSTRACT

A communication system includes a management device, a plurality of managed devices, and at least one target device. Each of the management device, the plurality of managed devices, and the at least one target device is capable of communicating with each other by selectively using one of a plurality of communication paths. The management device is configured to select a new communication path avoiding an abnormal section, and transmit a setting notification to at least the plurality of managed devices. At least one of the management device and the plurality of managed devices is configured to detect an abnormality in the communication path, and notify of the abnormality notification. The plurality of managed devices is configured to set the new communication path and perform communication according to the setting notification.

### CROSS REFERENCE TO RELATED APPLICATION

This application is based on Japanese Patent Application No. 2024-179771 filed on October 15, 2024, the disclosure of which is incorporated herein by reference.

### TECHNICAL FIELD

The present disclosure relates to a communication system including a plurality of electronic control units.

### BACKGROUND

A related art discloses an in-vehicle network system including a power relay for individually switching the power supply on/off for each of a plurality of electronic control units, in which, for a specific electronic control unit corresponding to a scene identified based on the status of the vehicle, the control content for switching the power supply on/off of the specific electronic control unit is determined, and based on the determined control content, the power supply to the specific electronic control unit is switched on/off using the power relay.

### SUMMARY

According to an aspect of the present disclosure, a communication system includes a management device; a plurality of managed devices managed by the management device; and at least one target device, which is a device communicably connected to at least one of the plurality of managed devices. Each of the management device, the plurality of managed devices, and the at least one target device is configured to communicate with each other by selectively using one of a plurality of communication paths. The management device is configured to select a new communication path avoiding an abnormal section when an abnormality notification indicating a notification capable of specifying the abnormal section, which is a section where an abnormality has occurred among the plurality of communication paths, is received; and transmit a setting notification, which is a notification indicating that communication is to be performed using the selected new communication path, to at least the plurality of managed devices. At least one of the management device and the plurality of managed devices is configured to detect an abnormality in the communication path; and notify of the abnormality notification regarding the detected abnormality. The plurality of managed devices is configured to set the new communication path and perform communication according to the setting notification. The setting notification includes switching information capable of identifying whether to set the plurality of managed devices and/or the target device to an on state or an off state.

### BRIEF DESCRIPTION OF DRAWINGS

Objects, features and advantages of the present disclosure will become more apparent from the following detailed description made with reference to the accompanying drawings. In the drawings:

FIG. 1 is a block diagram showing the configuration of a vehicle control system;

FIG. 2 is a flowchart illustrating frame transmission processing;

FIG. 3 is a flowchart illustrating frame transfer processing;

FIG. 4 is a flowchart illustrating fault detection processing;

FIG. 5 is a flowchart illustrating master activation processing;

FIG. 6 is a flowchart illustrating slave activation processing;

FIG. 7 is a flowchart illustrating reboot processing;

FIG. 8 is a flowchart illustrating master stop processing;

FIG. 9A is a flowchart illustrating slave stop processing,

FIG. 9B is a flowchart illustrating terminal stop processing; and

FIG. 10 is a flowchart illustrating slave detection processing.

### DETAILED DESCRIPTION

As a result of detailed studies by the inventors, it has been found that, in a communication system including a plurality of electronic control units and configured to allow individual switching between the on state and the off state for each of the plurality of electronic control units, there may be cases in which it becomes impossible to switch the electronic control unit between the on state and the off state, resulting in the occurrence of events where necessary communication cannot be performed.

The present disclosure provides a technique that suppresses the occurrence of events in which necessary communication cannot be performed in a communication system.

According to one aspect of the present disclosure, a communication system comprises: a management device; a plurality of managed devices managed by the management device; and at least one target device, which is a device communicably connected to at least one of the plurality of managed devices. Each of the management device, the plurality of managed devices, and the at least one target device is configured to be capable of communicating with each other by selectively using one of a plurality of communication paths. The management device includes: a communication path selection unit configured to select a new communication path avoiding an abnormal section when an abnormality notification indicating a notification capable of specifying the abnormal section, which is a section where an abnormality has occurred among the plurality of communication paths, is received; and a notification transmission unit configured to transmit a setting notification, which is a notification indicating that communication is to be performed using the selected new communication path, to at least the plurality of managed devices. At least one of the management device and the plurality of managed devices includes: an abnormality detection unit configured to detect an abnormality in the communication path; and an abnormality notification unit configured to notify the communication path selection unit of the abnormality notification regarding the detected abnormality. The plurality of managed devices includes: a path change unit configured to set the new communication path and perform communication according to the setting notification. The setting notification includes switching information capable of identifying whether to set the plurality of managed devices and/or the target device to an on state or an off state.

According to such a configuration, when an abnormality occurs in a communication path, it is possible to establish a new communication path that avoids the abnormal section and to communicate using this new communication path, thereby making it less likely that an event in which necessary communication cannot be performed will occur.

### First Embodiment

The first embodiment of the present disclosure will be described below with reference to the drawings.

### 1-1. Configuration

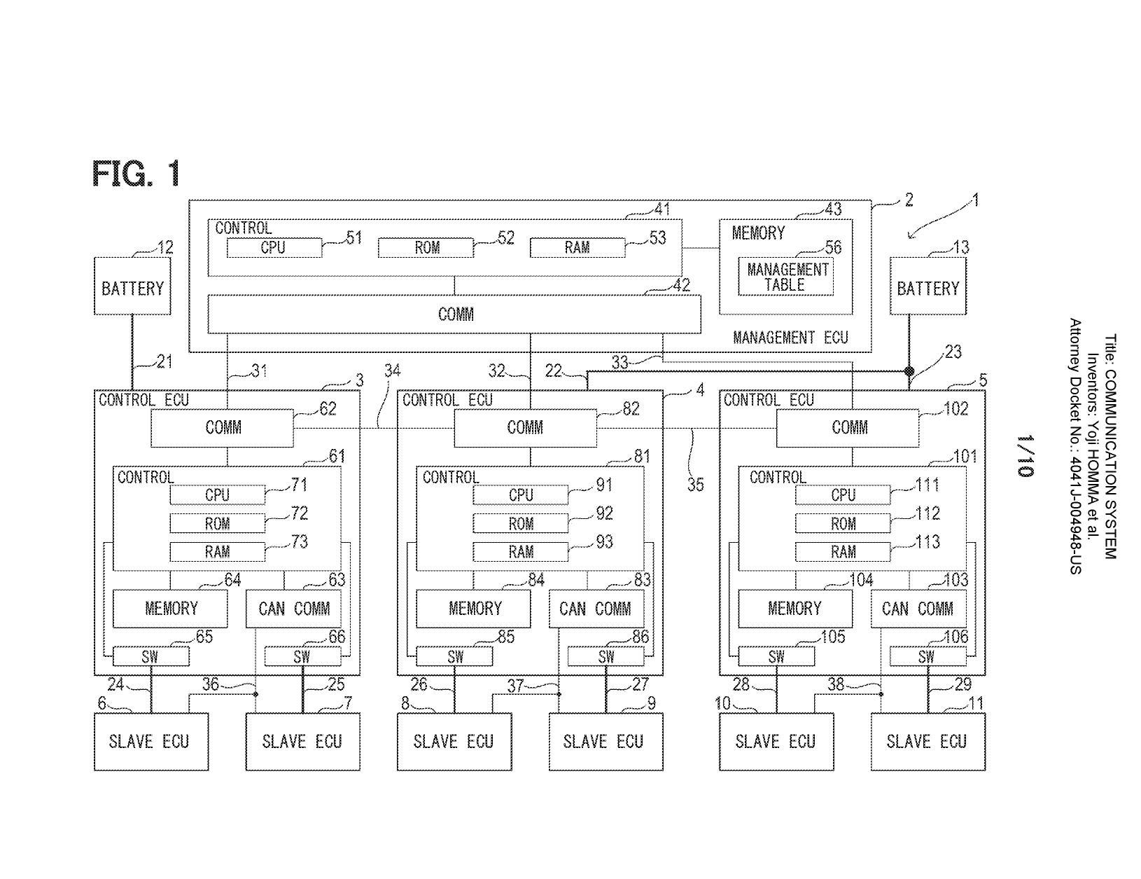

The vehicle control system 1 of the present embodiment is mounted on a vehicle and, as shown in FIG. 1, includes a management ECU 2, control ECUs 3, 4, and 5, slave ECUs 6, 7, 8, 9, 10, and 11, and batteries 12 and 13. ECU stands for Electronic Control Unit.

The management ECU 2 achieves coordinated control of the entire vehicle by supervising the control ECUs 3, 4, and 5. The control ECUs 3, 4, and 5 are provided for each of a plurality of zones into which the vehicle is divided, and mainly execute control of the slave ECUs present within their respective zones.

The slave ECUs 6 and 7 are ECUs belonging to the same zone as the control ECU 3. The slave ECUs 8 and 9 are ECUs belonging to the same zone as the control ECU 4. The slave ECUs 10 and 11 are ECUs belonging to the same zone as the control ECU 5.

The batteries 12 and 13 are DC batteries (for example, 12V) that supply electric power to various parts of the vehicle. The control ECU 3 receives power supply from the battery 12 via the power supply path 21 between the battery 12 and the control ECU 3.

The control ECU 4 receives power supply from the battery 13 via the power supply path 22 between the battery 13 and the control ECU 4. The control ECU 5 receives power supply from the battery 13 via the power supply path 23 between the battery 13 and the control ECU 5.

The slave ECUs 6 and 7 each receive power supply from the battery 12 via the power supply paths 24 and 25 between the control ECU 3 and the slave ECUs 6 and 7, respectively. The slave ECUs 8 and 9 each receive power supply from the battery 13 via the power supply paths 26 and 27 between the control ECU 4 and the slave ECUs 8 and 9, respectively.

The slave ECUs 10 and 11 each receive power supply from the battery 13 via the power supply paths 28 and 29 between the control ECU 5 and the slave ECUs 10 and 11, respectively. The management ECU 2 and the control ECU 3 are connected so as to be capable of data communication with each other via the communication line 31.

The management ECU 2 and the control ECU 4 are connected so as to be capable of data communication with each other via the communication line 32. The management ECU 2 and the control ECU 5 are connected so as to be capable of data communication with each other via the communication line 33.

The control ECUs 3 and 4 are connected so as to be capable of data communication with each other via the communication line 34. The control ECUs 4 and 5 are connected so as to be capable of data communication with each other via the communication line 35.

The control ECU 3 and the slave ECUs 6 and 7 are connected so as to be capable of data communication with each other via the communication bus 36. The control ECU 4 and the slave ECUs 8 and 9 are connected so as to be capable of data communication with each other via the communication bus 37.

The control ECU 5 and the slave ECUs 10 and 11 are connected so as to be capable of data communication with each other via the communication bus 38. The management ECU 2 includes a control unit 41, a communication unit 42, and a storage unit 43.

The control unit 41 is an electronic control device mainly including a microcomputer equipped with a CPU 51, ROM 52, RAM 53, and the like. Various functions of the microcomputer are realized by the CPU 51 executing a program stored in a non-transitory tangible recording medium. In this example, the ROM 52 corresponds to the non-transitory tangible recording medium storing the program. Further, by executing this program, a method corresponding to the program is executed. Note that some or all of the functions executed by the CPU 51 may be configured in hardware by one or more ICs or the like. The number of microcomputers constituting the control unit 41 may be one or more.

The communication unit 42 performs communication by transmitting and receiving communication frames, for example, based on the Ethernet communication protocol, between the control ECU 3 connected via the communication line 31, the control ECU 4 connected via the communication line 32, and the control ECU 5 connected via the communication line 33. Ethernet is a registered trademark.

The storage unit 43 is a storage device for storing various types of data. The storage unit 43 stores a management table 56, which will be described later. The control ECU 3 includes a control unit 61, a communication unit 62, a CAN communication unit 63, a storage unit 64, and power distribution switches 65 and 66. CAN stands for Controller Area Network.

The control unit 61 is an electronic control device mainly including a microcomputer equipped with a CPU 71, ROM 72, RAM 73, and the like. Various functions of the microcomputer are realized by the CPU 71 executing a program stored in a non-transitory tangible recording medium. In this example, the ROM 72 corresponds to the non-transitory tangible recording medium storing the program. Further, by executing this program, a method corresponding to the program is executed. Note that some or all of the functions executed by the CPU 71 may be configured in hardware by one or more ICs or the like. The number of microcomputers constituting the control unit 61 may be one or more.

The communication unit 62 performs communication by transmitting and receiving communication frames, for example, based on the Ethernet communication protocol, between the management ECU 2 connected via the communication line 31 and the control ECU 4 connected via the communication line 34.

The CAN communication unit 63 performs communication by transmitting and receiving communication frames based on the CAN communication protocol between the slave ECUs 6 and 7 connected via the communication bus 36. The storage unit 64 is a storage device for storing various types of data.

The power distribution switch 65 is disposed on the power supply path 24, which is connected to the power supply path 21. The power distribution switch 65 is configured to conduct or interrupt the power supply path 24 in accordance with commands from the control unit 61.

The power distribution switch 66 is disposed on the power supply path 25, which is connected to the power supply path 21. The power distribution switch 66 is configured to conduct or interrupt the power supply path 25 in accordance with commands from the control unit 61.

The control ECU 4 includes a control unit 81, a communication unit 82, a CAN communication unit 83, a storage unit 84, and power distribution switches 85 and 86. The control unit 81 is an electronic control device mainly including a microcomputer equipped with a CPU 91, ROM 92, RAM 93, and the like. Various functions of the microcomputer are realized by the CPU 91 executing a program stored in a non-transitory tangible recording medium. In this example, the ROM 92 corresponds to the non-transitory tangible recording medium storing the program. Further, by executing this program, a method corresponding to the program is executed. Note that some or all of the functions executed by the CPU 91 may be configured in hardware by one or more ICs or the like. The number of microcomputers constituting the control unit 81 may be one or more.

The communication unit 82 performs communication by transmitting and receiving communication frames, for example, based on the Ethernet communication protocol, between the management ECU 2 connected via the communication line 32, the control ECU 3 connected via the communication line 34, and the control ECU 5 connected via the communication line 35.

The CAN communication unit 83 performs communication by transmitting and receiving communication frames based on the CAN communication protocol between the slave ECUs 8 and 9 connected via the communication bus 37. The storage unit 84 is a storage device for storing various types of data.

The power distribution switch 85 is disposed on the power supply path 26, which is connected to the power supply path 22. The power distribution switch 85 is configured to conduct or interrupt the power supply path 26 in accordance with commands from the control unit 81.

The power distribution switch 86 is disposed on the power supply path 27, which is connected to the power supply path 22. The power distribution switch 86 is configured to conduct or interrupt the power supply path 27 in accordance with commands from the control unit 81.

The control ECU 5 includes a control unit 101, a communication unit 102, a CAN communication unit 103, a storage unit 104, and power distribution switches 105 and 106. The control unit 101 is an electronic control device mainly including a microcomputer equipped with a CPU 111, ROM 112, RAM 113, and the like. Various functions of the microcomputer are realized by the CPU 111 executing a program stored in a non-transitory tangible recording medium. In this example, the ROM 112 corresponds to the non-transitory tangible recording medium storing the program. Further, by executing this program, a method corresponding to the program is executed. Note that some or all of the functions executed by the CPU 111 may be configured in hardware by one or more ICs or the like. The number of microcomputers constituting the control unit 101 may be one or more.

The communication unit 102 performs communication by transmitting and receiving communication frames, for example, based on the Ethernet communication protocol, between the management ECU 2 connected via the communication line 33 and the control ECU 4 connected via the communication line 35.

The CAN communication unit 103 performs communication by transmitting and receiving communication frames based on the CAN communication protocol between the slave ECUs 10 and 11 connected via the communication bus 38. The storage unit 104 is a storage device for storing various types of data.

The power distribution switch 105 is disposed on the power supply path 28, which is connected to the power supply path 23. The power distribution switch 105 is configured to conduct or interrupt the power supply path 28 in accordance with commands from the control unit 101.

The power distribution switch 106 is disposed on the power supply path 29, which is connected to the power supply path 23. The power distribution switch 106 is configured to conduct or interrupt the power supply path 29 in accordance with commands from the control unit 101.

In the management table 56, for each of a plurality of events, the correspondence between the event and the power distribution switches to be set to the on state and the power distribution switches to be set to the off state is established. Specifically, in the management table 56, for each event, six pieces of switching information are set, indicating whether each of the power distribution switches 65, 66, 85, 86, 105, and 106 is to be set to the on state or the off state.

For example, for an event in which the vehicle power state switches from accessory-on state to ignition-on state, the six pieces of switching information may be set as follows: power distribution switch 65 to the on state, power distribution switch 66 to the on state, power distribution switch 85 to the off state, power distribution switch 86 to the off state, power distribution switch 105 to the on state, and power distribution switch 106 to the off state.

For example, for a door open event in which the vehicle door is opened, the six pieces of switching information may be set as follows: power distribution switch 65 to the off state, power distribution switch 66 to the off state, power distribution switch 85 to the on state, power distribution switch 86 to the on state, power distribution switch 105 to the off state, and power distribution switch 106 to the on state.

For example, when the slave ECU 6 is a door control ECU, if the door switch is turned on, the slave ECU 6 transmits information indicating the door open event to the management ECU 2 via the control ECU 4. As a result, the management ECU 2 can detect the occurrence of the door open event.

When the management ECU 2 detects an event, it extracts the six pieces of switching information corresponding to the detected event from the management table 56. The management ECU 2 then generates a communication frame including the extracted six pieces of switching information as an NM frame. NM stands for Network Management. The generated NM frame is transmitted.

When the control ECU 3 receives the NM frame transmitted by the management ECU 2, it extracts the switching information for the subordinate power distribution switches 65 and 66 from the NM frame, and sets the power distribution switches 65 and 66 to the on state or the off state based on the extracted switching information.

When the control ECU 4 receives the NM frame transmitted by the management ECU 2, the control ECU 4 extracts the switching information for the subordinate power distribution switches 85 and 86 from the NM frame, and sets the power distribution switches 85 and 86 to the on state or the off state based on the extracted switching information.

When the control ECU 5 receives the NM frame transmitted by the management ECU 2, the control ECU 5 extracts the switching information for the subordinate power distribution switches 105 and 106 from the NM frame, and sets the power distribution switches 105 and 106 to the on state or the off state based on the extracted switching information.

### 1-2. Processing

Next, the procedure for frame transmission processing executed by the control unit 41 of the management ECU 2 will be described. The frame transmission processing is a process that is repeatedly executed during the operation of the management ECU 2.

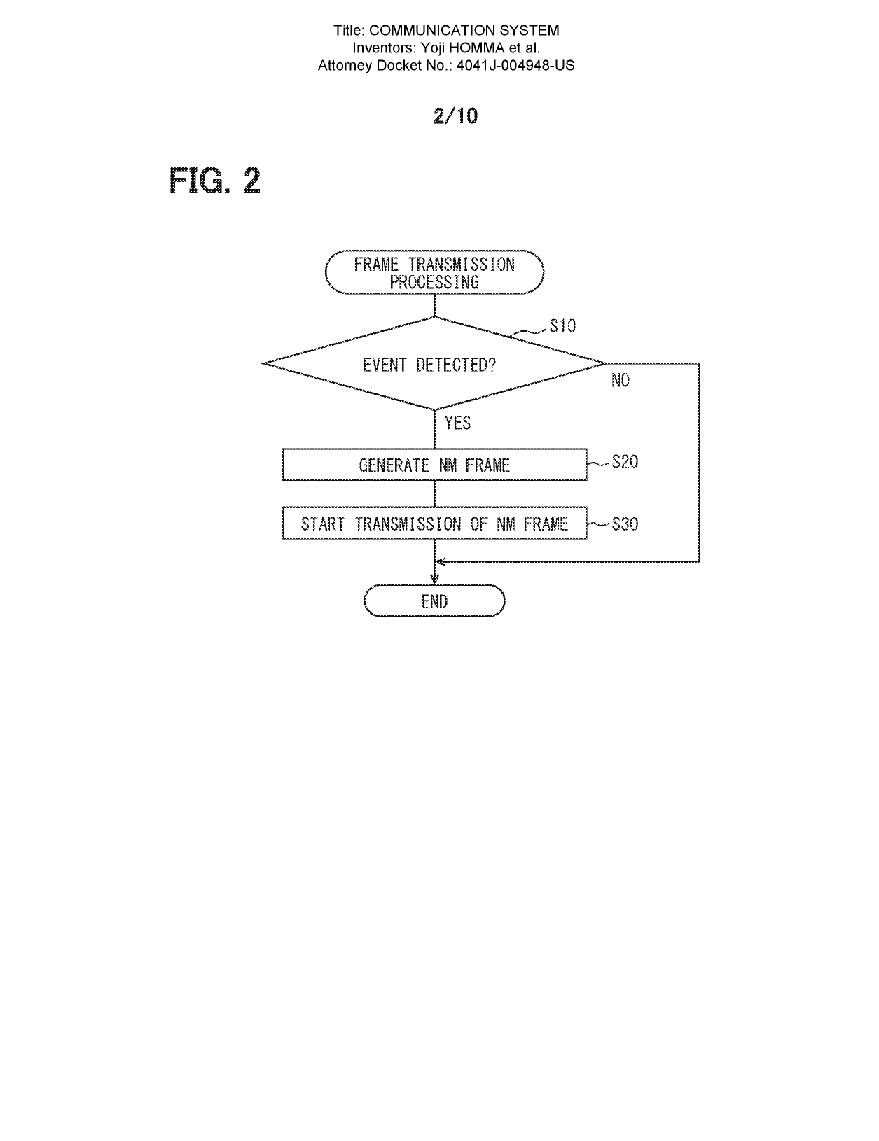

When the frame transmission processing is executed, the CPU 51 of the control unit 41 determines, at S10 as shown in FIG. 2, whether an event has been detected. If no event is detected, the CPU 51 terminates the frame transmission processing.

On the other hand, if an event is detected, the CPU 51 extracts, at S20, the six pieces of switching information corresponding to the detected event from the management table 56, and generates an NM frame including the extracted six pieces of switching information.

At S30, the CPU 51 starts processing to transmit the NM frame generated at S20 to the control ECUs 3, 4, and 5 via the respective communication lines 31, 32, and 33, and then terminates the frame transmission processing. As a result, the management ECU 2 periodically and repeatedly transmits the NM frame generated at S20.

Next, the procedure for frame transfer processing executed by the control units 61, 81, and 101 of the control ECUs 3, 4, and 5 will be described. The frame transfer processing is a process that is repeatedly executed during the operation of the control ECUs 3, 4, and 5.

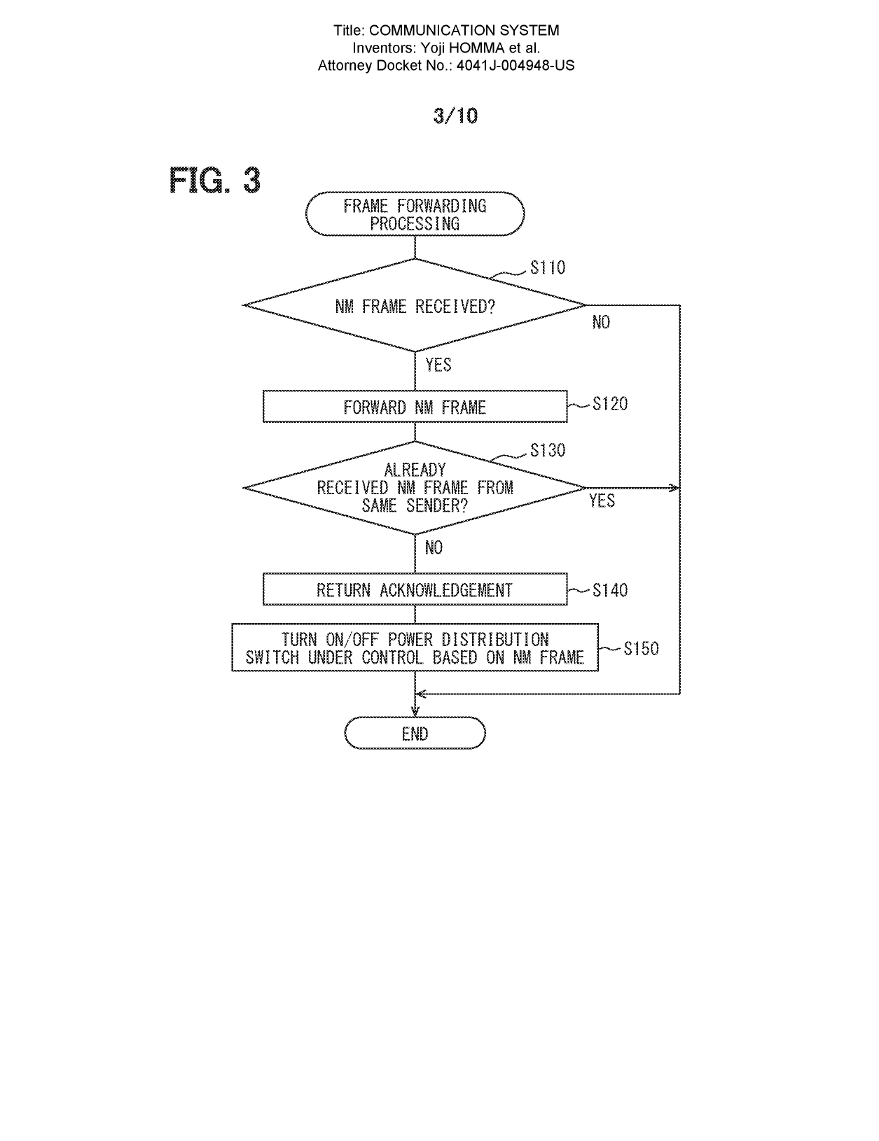

When the frame transfer processing is executed, the CPUs 71, 91, and 111 of the control units 61, 81, and 101 determine, at S110 as shown in FIG. 3, whether an NM frame has been received. If no NM frame is received, the CPUs 71, 91, and 111 terminate the frame transfer processing.

On the other hand, if an NM frame is received, the CPUs 71, 91, and 111, at S120, transfer the received NM frame via the remaining communication lines, excluding the communication lines 31, 32, and 33 connected to the management ECU 2 and the communication line on which the NM frame was received at S110.

For example, when the control ECU 3 receives an NM frame from the management ECU 2 via the communication line 31, it transfers the NM frame to the control ECU 4 via the communication line 34. If the control ECU 3 receives an NM frame from the control ECU 4 via the communication line 34, it does not execute the transfer of the NM frame.

For example, when the control ECU 4 receives an NM frame from the management ECU 2 via the communication line 32, it transfers the NM frame to the control ECUs 3 and 5 via the communication lines 34 and 35, respectively. If the control ECU 4 receives an NM frame from the control ECU 3 via the communication line 34, it transfers the NM frame to the control ECU 5 via the communication line 35.

If the control ECU 4 receives an NM frame from the control ECU 5 via the communication line 35, it transfers the NM frame to the control ECU 3 via the communication line 34. For example, when the control ECU 5 receives an NM frame from the management ECU 2 via the communication line 33, the control ECU 5 transfers the NM frame to the control ECU 4 via the communication line 35.

If the control ECU 5 receives an NM frame from the control ECU 4 via the communication line 35, the control ECU 5 does not execute the transfer of the NM frame. At S130, the CPUs 71, 91, and 111 determine whether an NM frame from the same transmission source (i.e., the management ECU 2) has already been received during the period between a predetermined time (a reception determination time) before the time at which it is determined at S110 that the NM frame has been received and that time at which it is determined at S110 that the NM frame has been received (hereinafter referred to as the same frame reception determination period). Note that the NM frame includes a transmission source address indicating the transmission source.

The same frame reception determination period is set based on the difference in timing of receiving NM frames via multiple communication lines when the control ECU receives NM frames via a plurality of communication lines.

For example, in the control ECU 4, the same frame reception determination period is set based on the difference in timing when receiving an NM frame via the communication line 31, when receiving an NM frame via the communication lines 32 and 34, and when receiving an NM frame via the communication lines 33, 34, and 35. The same frame reception determination period may be the same for the control ECUs 3, 4, and 5, or may be different for each of the control ECUs 3, 4, and 5.

Here, if an NM frame from the same transmission source has already been received within the same frame reception determination period, the CPUs 71, 91, and 111 terminate the frame transfer processing. On the other hand, if an NM frame from the same transmission source has not already been received within the same frame reception determination period, the CPUs 71, 91, and 111, at S140, return an acknowledgment via the communication line on which the NM frame was received at S110.

For example, when the control ECU 4 receives an NM frame from the management ECU 2 via the communication line 32, it returns an acknowledgment to the management ECU 2 via the communication line 32. Further, when the control ECU 4 receives an NM frame from the control ECU 3 via the communication line 34, it returns an acknowledgment to the control ECU 3 via the communication line 34.

At S150, the CPUs 71, 91, and 111 set the subordinate power distribution switches to the on state or the off state based on the switching information included in the NM frame received at S110, and terminate the frame transfer processing.

Next, the procedure for fault detection processing executed by the control units 61, 81, and 101 of the control ECUs 3, 4, and 5 will be described. The fault detection processing is a process that is repeatedly executed during the operation of the control ECUs 3, 4, and 5.

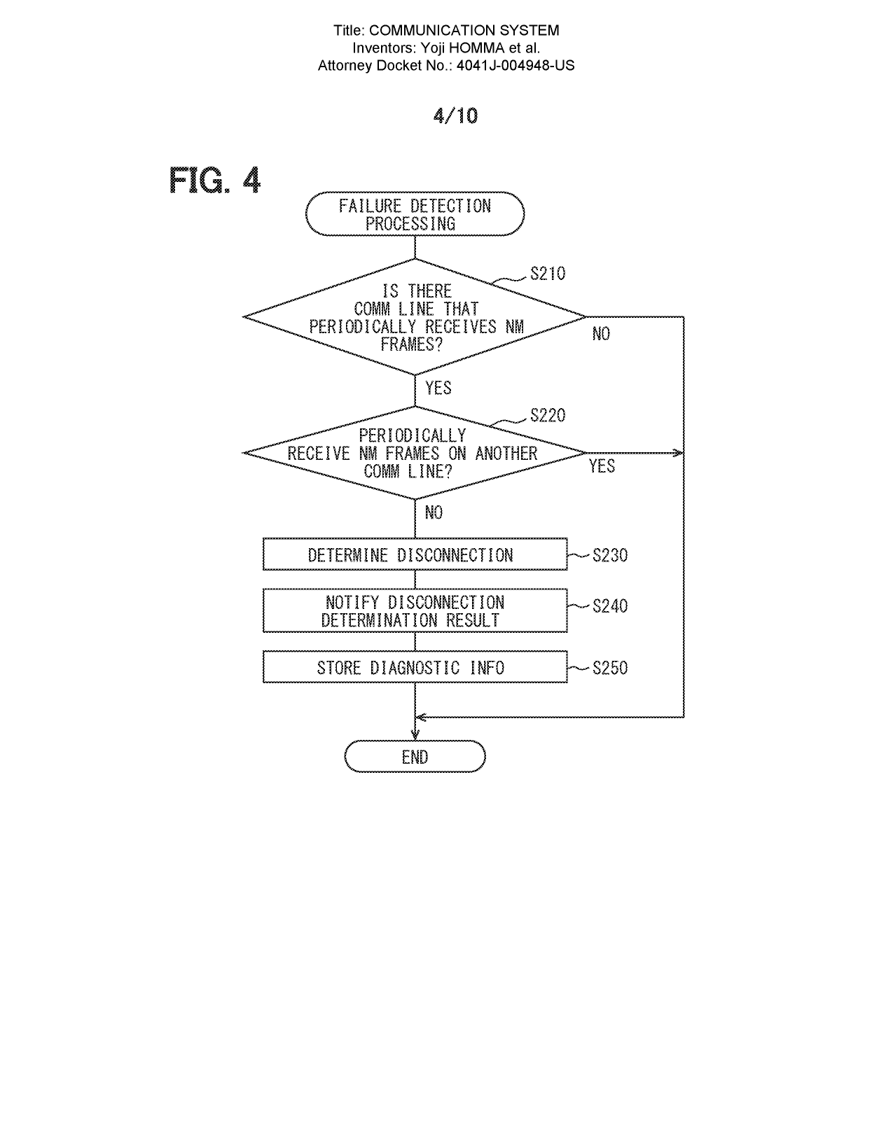

When the fault detection processing is executed, the CPUs 71, 91, and 111 of the control units 61, 81, and 101 determine, at S210 as shown in FIG. 4, whether there is currently a communication line on which NM frames are being periodically received. If there is no communication line on which NM frames are being periodically received, the CPUs 71, 91, and 111 terminate the fault detection processing.

On the other hand, if there is currently a communication line on which NM frames are being periodically received, the CPUs 71, 91, and 111, at S220, determine whether NM frames are also being periodically received on other communication lines, apart from the communication line identified at S210.

Here, if NM frames are being periodically received on other communication lines apart from the communication line identified at S210, the CPUs 71, 91, and 111 terminate the fault detection processing. On the other hand, if NM frames are not being periodically received on other communication lines apart from the communication line identified at S210, the CPUs 71, 91, and 111, at S230, determine that a communication interruption has occurred on the communication line on which NM frames are not being periodically received.

For example, if the communication line 32 is disconnected, the control ECU 4 periodically receives NM frames from the control ECUs 3 and 5 via the communication lines 34 and 35, respectively, but cannot receive NM frames from the management ECU 2 via the communication line 32. Therefore, the control ECU 4 determines that a communication interruption has occurred on the communication line 32.

For example, if the communication line 34 is disconnected, the control ECU 4 periodically receives NM frames from the management ECU 2 and the control ECU 5 via the communication lines 32 and 35, respectively, but cannot receive NM frames from the control ECU 3 via the communication line 34. Therefore, the control ECU 4 determines that a communication interruption has occurred on the communication line 34.

For example, if the communication line 31 is disconnected, the control ECU 3 periodically receives NM frames from the control ECU 4 via the communication line 34, but cannot receive NM frames from the management ECU 2 via the communication line 31. Therefore, the control ECU 3 determines that a communication interruption has occurred on the communication line 31.

At S240, the CPUs 71, 91, and 111 notify the management ECU 2 of a disconnection determination result indicating the communication line on which a communication interruption has occurred. Upon receiving the disconnection determination result, the management ECU 2, as a fail-safe action, stores diagnostic information indicating the received disconnection determination result in the storage unit 43. Further, the management ECU 2 that has received the disconnection determination result may notify the vehicle occupants that a communication interruption has occurred.

At S250, the CPUs 71, 91, and 111 store, in the storage units 64, 84, and 104, the diagnostic information indicating the disconnection determination result notified at S240, and terminate the fault detection processing. Note that this fault detection processing may be omitted when the communication partner control ECU is in a sleep state.

### 1-3. Effects

According to the first embodiment described in detail above, the following effects are achieved.

(1a) The vehicle control system 1 configured as described above includes ECUs 2 to 11, which are connected so as to be capable of transmitting and receiving communication frames. The vehicle control system 1 includes the control ECU 3, the control ECU 4, the slave ECU 6, the slave ECU 8, the power distribution switch 65, the power distribution switch 85, the management ECU 2, the communication line 31, the communication line 32, and the communication line 34.

The control ECU 3 is configured to receive power supply via the power supply path 21. The control ECU 4 is configured to receive power supply via the power supply path 22, which is not connected to the power supply path 21.

The slave ECU 6 is configured to receive power supply via the power supply path 24, which is connected to the power supply path 21. The slave ECU 8 is configured to receive power supply via the power supply path 26, which is connected to the power supply path 22.

The power distribution switch 65 is configured to switch between an on state, in which the power supply path 24 is conducted, and an off state, in which the power supply path 24 is interrupted. The power distribution switch 85 is configured to switch between an on state, in which the power supply path 26 is conducted, and an off state, in which the power supply path 26 is interrupted.

The management ECU 2 is configured to generate an NM frame, which is a communication frame including switching information indicating whether each of the power distribution switches 65 and 85 should be set to the on state or the off state, in accordance with the detected event.

The communication line 31 is a communication path that connects the management ECU 2 and the control ECU 3 so as to enable transmission and reception of communication frames between them. The communication line 32 is a communication path that connects the management ECU 2 and the control ECU 4 so as to enable transmission and reception of communication frames between them.

The communication line 34 is a communication path that connects the control ECU 3 and the control ECU 4 so as to enable transmission and reception of communication frames between them. The management ECU 2 is configured to transmit NM frames to the control ECU 3 via the communication line 31.

The management ECU 2 is configured to transmit NM frames to the control ECU 4 via the communication line 32. The control ECU 3 is configured to control the operation of the power distribution switch 65 based on the switching information included in the NM frame.

The control ECU 4 is configured to control the operation of the power distribution switch 85 based on the switching information included in the NM frame. In such a vehicle control system 1, since the management ECU 2 generates NM frames according to events and transmits the NM frames to the control ECUs 3 and 4 via the communication lines 31 and 32, the control ECUs 3 and 4 can set the power distribution switches 65 and 85 to the on state or the off state according to the events.

Furthermore, in the vehicle control system 1, even if the management ECU 2 is unable to transmit NM frames to the control ECU 3 via the communication line 31, the management ECU 2 can transmit NM frames to the control ECU 3 via the communication line 32 and the communication line 34. Similarly, even if the management ECU 2 is unable to transmit NM frames to the control ECU 4 via the communication line 32, the management ECU 2 can transmit NM frames to the control ECU 4 via the communication line 31 and the communication line 34. Therefore, the vehicle control system 1 can suppress the occurrence of a situation in which it becomes impossible to switch between permitting and prohibiting power supply to the slave ECUs 6 and 8.

(1b) Furthermore, in the vehicle control system 1, even if the control ECU 3 becomes unable to control the operation of the power distribution switch 65 due to being unable to receive power supply via the power supply path 21, the control ECU 4, which receives power supply via the power supply path 22 not connected to the power supply path 21, can control the operation of the power distribution switch 85. Therefore, the vehicle control system 1 can suppress the occurrence of a situation in which it becomes impossible to simultaneously switch between permitting and prohibiting power supply to both slave ECUs 6 and 8. From the above, the vehicle control system 1 can suppress the occurrence of a situation in which it becomes impossible to switch between permitting and prohibiting power supply to the electronic control units.

(1c) Furthermore, the control ECU 3 is configured to transmit the NM frame received from the management ECU 2 to the control ECU 4 via the communication line 34, even when it is possible to use the communication line 32. Similarly, the control ECU 4 is configured to transmit the NM frame received from the management ECU 2 to the control ECU 3 via the communication line 34, even when it is possible to use the communication line 31. In such a vehicle control system 1, the control ECUs 3 and 4 transmit NM frames via the communication line 34 even during normal operation when both communication lines 31 and 32 are available. Therefore, the vehicle control system 1 can omit processing for determining whether the communication lines 31 and 32 are available.

(1d) Furthermore, the vehicle control system 1 further includes control ECU 5, slave ECU 10, power distribution switch 105, communication line 33, and communication line 35. The control ECU 5 is configured to receive power supply via the power supply path 23, which is not connected to the power supply path 21 and is connected to the power supply path 22.

The slave ECU 10 is configured to receive power supply via the power supply path 28, which is connected to the power supply path 23. The power distribution switch 105 is configured to switch between an on state, in which the power supply path 28 is conducted, and an off state, in which the power supply path 28 is interrupted.

The communication line 33 is a communication path that connects the management ECU 2 and the control ECU 5 so as to enable transmission and reception of communication frames between them. The communication line 35 is a communication path that connects the control ECU 4 and the control ECU 5 so as to enable transmission and reception of communication frames between them.

The NM frame further includes switching information indicating whether the power distribution switch 105 is to be set to the on state or the off state. The management ECU 2 is configured to transmit NM frames to the control ECU 5 via the communication line 35.

The control ECU 5 is configured to control the operation of the power distribution switch 105 based on the switching information included in the NM frame. In such a vehicle control system 1, even when the communication lines 31 and 32 cannot be used, NM frames can be transmitted to the control ECUs 3 and 4 via the communication lines 33, 34, and 35, thereby further suppressing the occurrence of a situation in which it becomes impossible to switch between permitting and prohibiting power supply to the slave ECUs 6 and 8.

(1e) Furthermore, the control ECU 3 is configured such that, when NM frames are received from each of the communication lines 31 and 34 connected to the control ECU 3 within a preset same frame reception determination period, the power distribution switch 65 is set to the on state or the off state based on the NM frame received first. The control ECU 4 is configured such that, when NM frames are received from each of the communication lines 32, 34, and 35 connected to the control ECU 4 within a preset same frame reception determination period, the power distribution switch 85 is set to the on state or the off state based on the NM frame received first. The control ECU 5 is configured such that, when NM frames are received from each of the communication lines 33 and 35 connected to the control ECU 5 within a preset same frame reception determination period, the power distribution switch 105 is set to the on state or the off state based on the NM frame received first.

In such a vehicle control system 1, when the control ECUs 3, 4, and 5 receive the same NM frame multiple times, it is possible to avoid the control ECUs 3, 4, and 5 unnecessarily repeating the same control for the power distribution switches 65, 85, and 105.

(1f) Furthermore, each of the control ECUs 3, 4, and 5 is configured to determine that a communication interruption has occurred on a communication line 31 to 35 on which NM frames are not being periodically received, when at least one of the communication lines 31 to 35 connected to the respective control ECU is periodically receiving a management frame, and at least one of the communication lines 31 to 35 connected to the respective control ECU is not periodically receiving an NM frame. In such a vehicle control system 1, it is possible to specify the communication line 31 to 35 on which an abnormality has occurred.

(1g) Furthermore, each of the control ECUs 3, 4, and 5 is configured to notify the management ECU 2 of the disconnection determination result when it is determined that a communication interruption has occurred.

In such a vehicle control system 1, the management ECU 2 can recognize which of the communication lines 31 to 35 has experienced an abnormality.

While an embodiment of the present disclosure has been described above, the present disclosure is not limited to the above embodiment and may be implemented in various modified forms.

### 1-4. Modification Example 1 of the First Embodiment

In the above embodiment, a configuration was described in which an acknowledgment is returned when an NM frame from the same transmission source has not already been received within the same frame reception determination period. However, it is also possible to return an acknowledgment even when an NM frame from the same transmission source has already been received within the same frame reception determination period.

### 2. Second Embodiment

### (2-1. Differences from the First Embodiment)

The second embodiment has a basic configuration similar to that of the first embodiment, and the differences will be described below. Note that the same reference numerals as in the first embodiment indicate the same components, and reference is made to the preceding description.

In the first embodiment described above, the management ECU 2 transmits NM frames to each of the plurality of communication lines 31 to 33, and the control ECUs 3, 4, and 5 are configured to relay NM frames to each other. In contrast, in the second embodiment, a communication path (for example, a normally used communication path) to be used for each communication partner is preset, and the management ECU 2 transmits NM frames only to one of the communication lines 31 to 33 corresponding to the communication path set for the given communication partner. The NM frame is then relayed according to that communication path, which is a point of difference from the first embodiment.

### 2-2. Correspondence with the Present Disclosure

In the second embodiment, the vehicle control system 1 corresponds to the communication system, and the management ECU 2 corresponds to the management device. The control ECUs 3, 4, and 5 correspond to the plurality of managed devices, and some of the slave ECUs 6 to 11 and control ECUs 3, 4, and 5 correspond to the target devices. Among the processes executed by the vehicle control system 1, the functions of S310 and S710 correspond to the abnormality detection unit, the function of S330 corresponds to the communication path selection unit, the function of S360 corresponds to the activation transmission unit and the notification transmission unit, the functions of S370 and S530 correspond to the time calculation unit, the function of S415 corresponds to the path change unit, the functions of S325 and S730 correspond to the abnormality notification unit, and the functions of S450 and S550 correspond to the processing execution unit.

### (2-3. Configuration)

As described above, in the vehicle control system 1 of the second embodiment, a communication path is preset for each communication partner. Specifically, the storage unit 43 of the management ECU 2 and the storage units 64, 84, and 104 of the control ECUs 3, 4, and 5 store, in a rewritable manner, information regarding the communication path to be used for each communication partner. The information regarding the communication path includes, for example, information about which communication lines 31 to 38 should be used for each communication partner, information about the corresponding ports, and other necessary information for performing communication along the designated communication path.

The communication paths between the devices constituting the vehicle control system 1 (i.e., the management ECU 2, control ECUs 3, 4, and 5, and slave ECUs 6 to 11) are basically set so as to minimize the number of hops. For example, the communication path from the management ECU 2 to the slave ECU 6 is set so that communication is performed in the order of communication line 31, control ECU 3, and communication bus 36. For example, the communication path from the slave ECU 8 to the management ECU 2 is set so that communication is performed in the order of communication bus 37, control ECU 4, and communication line 32. For example, the communication path from the slave ECU 6 to the slave ECU 8 is set so that communication is performed in the order of communication bus 36, control ECU 3, communication line 34, control ECU 4, and communication bus 37.

### 2-4. Processing

In the second embodiment, it is assumed that a communication interruption has occurred, and various processes are provided to ensure that NM frames can be relayed properly in such cases. These processes include (A) a process for activating a slave ECU and (B) a process for stopping a slave ECU.

First, as (A) the process for activating a slave ECU, the process for activating the slave ECU 6 will be described. Note that the process described below is not limited to the activation of the slave ECU 6, but can be applied to a process for transmitting an NM frame to a specified communication partner.

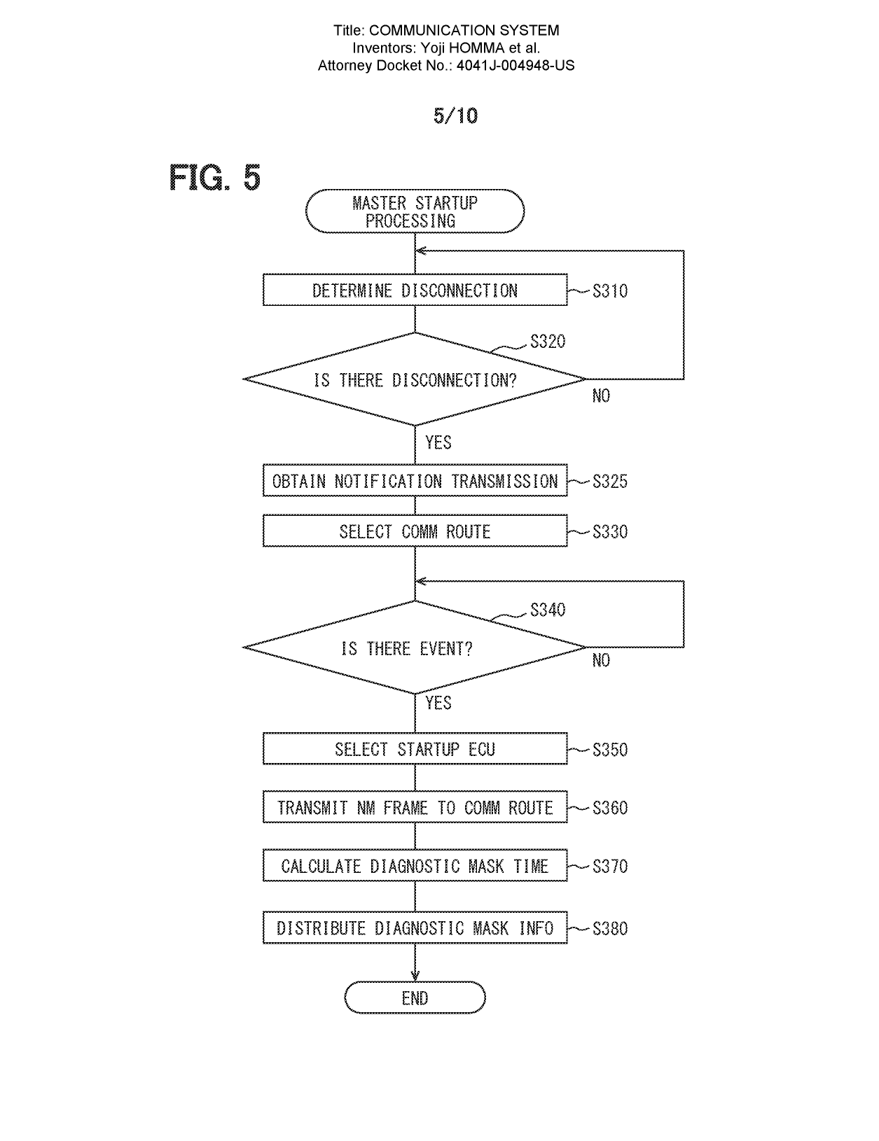

FIG. 5 is a flowchart illustrating the master activation processing. The master activation processing is a process that is started, for example, when the management ECU 2 is activated, and is executed by the CPU 51 of the management ECU 2.

In the master activation processing, as shown in FIG. 5, first, at S310, the CPU 51 of the management ECU 2 performs a disconnection determination. This process is the same as S230 described above. That is, in this process, a communication interruption is detected. In this process, for example, an abnormality in the communication path such as a disconnection or excessive delay may also be detected.

Subsequently, at S320, the CPU 51 of the management ECU 2 determines whether a communication interruption has occurred. If there is no communication interruption, the process returns to S310. If a communication interruption is present, the process proceeds to S325. Subsequently, at S325, the CPU 51 of the management ECU 2 notifies, within the management ECU 2, an abnormality notification regarding the detected abnormality. That is, the function for notifying an abnormality in the management ECU 2 transmits the abnormality notification, and the function for selecting the communication path in the management ECU 2 (for example, the function of S330 described below) acquires the abnormality notification. The abnormality notification is a notification including information for specifying the abnormal section, which is the section where an abnormality has occurred among the plurality of communication paths (for example, any of the communication lines 31 to 35).

Subsequently, at S330, the CPU 51 of the management ECU 2, upon receiving the abnormality notification, selects a new communication path that avoids the abnormal section. Specifically, for example, in the case where the communication path from the management ECU 2 to the slave ECU 6 shown in FIG. 1 includes the communication line 31 and the communication bus 36, and a communication interruption is detected on the communication line 31, a new communication path that avoids the communication line 31 is established.

The management ECU 2 stores, in the storage unit 43, a routing map as options for selecting communication paths, taking into account which devices are connected via which communication lines. For example, as a new communication path avoiding the communication line 31, the management ECU 2 selects a path from the management ECU 2 to the slave ECU 6 in the order of communication line 32, control ECU 4, communication line 34, control ECU 3, and communication bus 36.

The management ECU 2 stores the new communication path and the communication path used before the abnormality was detected (hereinafter, the previous communication path, or may be referred to as an old communication path) in the storage unit 43. These new and previous communication paths are configured to be readable from the storage unit 43 when the management ECU 2 is rebooted. Note that “reboot” may be referred to as restart.

Subsequently, at S340, the CPU 51 of the management ECU 2 determines whether an event has occurred. The event here may be the same as the event in S10 described above, or may be another event. In one example of this embodiment, it is determined whether there is an event for activating the slave ECU 6. If there is no event, S340 is repeated. If there is an event, the process proceeds to S350.

Subsequently, at S350, the CPU 51 of the management ECU 2 selects the ECU to be activated according to the event. In one example of this embodiment, the slave ECU 6 is selected. Subsequently, at S360, the CPU 51 of the management ECU 2 transmits an NM frame to the new communication path. This NM frame includes a setting notification and an activation command. The setting notification is a notification to the devices constituting the new communication path, including the plurality of control ECUs 3, 4, and 5, indicating that communication is to be performed using the selected new communication path. The activation command is a command to activate the slave ECU 6.

Subsequently, at S370, the management ECU 2 is configured to calculate the diagnostic mask time. The diagnostic mask time is the time until a device (for example, control ECU 3, etc.) newly joining the network operates normally. The diagnostic mask time is calculated based on the known activation time of the slave ECU 6. Note that each ECU constituting the vehicle control system 1 is configured to transmit a diagnostic (for example, error code) when communication with a communication partner ECU is interrupted (for example, times out). In this embodiment, each ECU ignores frames related to a device newly joining the network for the duration of the diagnostic mask time. Thus, the diagnostic mask means temporarily ignoring frames from the relevant ECU, so that even if communication is determined to be interrupted by any ECU, it is not regarded as an abnormality.

Further, the diagnostic mask time may be set in consideration of an increase in communication delay time accompanying a longer communication path. Not only for the diagnostic mask time, but also when setting the SW OFF time described later, the increase in communication delay time may be considered. When there is no communication interruption, the diagnostic mask time for the slave ECU 6 is, for example, a value calculated based on the activation time of the slave ECU 6 and the delay time on the previous communication path (for example, communication line 31 and communication bus 36). On the other hand, when there is a communication interruption, the diagnostic mask time is a value calculated based on the activation time of the slave ECU 6 and the delay time on the new communication path (for example, with control ECU 4 added, communication line 32, communication line 34, and communication bus 36). Additionally, each device constituting the vehicle control system 1 may perform time synchronization, in which the timing of signal transmission and reception is determined according to a common time. In this case, the time synchronization may be corrected according to the communication delay time. That is, the time held by each ECU may be corrected in consideration of the communication delay time to enable accurate synchronization. Furthermore, the control timing may be adjusted in consideration of the communication delay time. For example, the control timing may be adjusted so that the ECU receiving the frame last receives it at the appropriate timing.

When the diagnostic mask time for the communication partner device is set in each device, signals related to the corresponding communication partner device are ignored during the diagnostic mask time. More specifically, for example, during the diagnostic mask time for the slave ECU 6, all devices ignore signals related to the slave ECU 6.

Subsequently, at S380, the CPU 51 of the management ECU 2 is configured to notify at least the plurality of control ECUs 3, 4, and 5 of the diagnostic mask information. The diagnostic mask information includes the diagnostic mask time. When this processing is completed, the present processing ends. Note that the diagnostic mask time may also be notified from the control ECU 3 to the slave ECUs 6 and 7, from the control ECU 4 to the slave ECUs 8 and 9, and from the control ECU 5 to the slave ECUs 10 and 11.

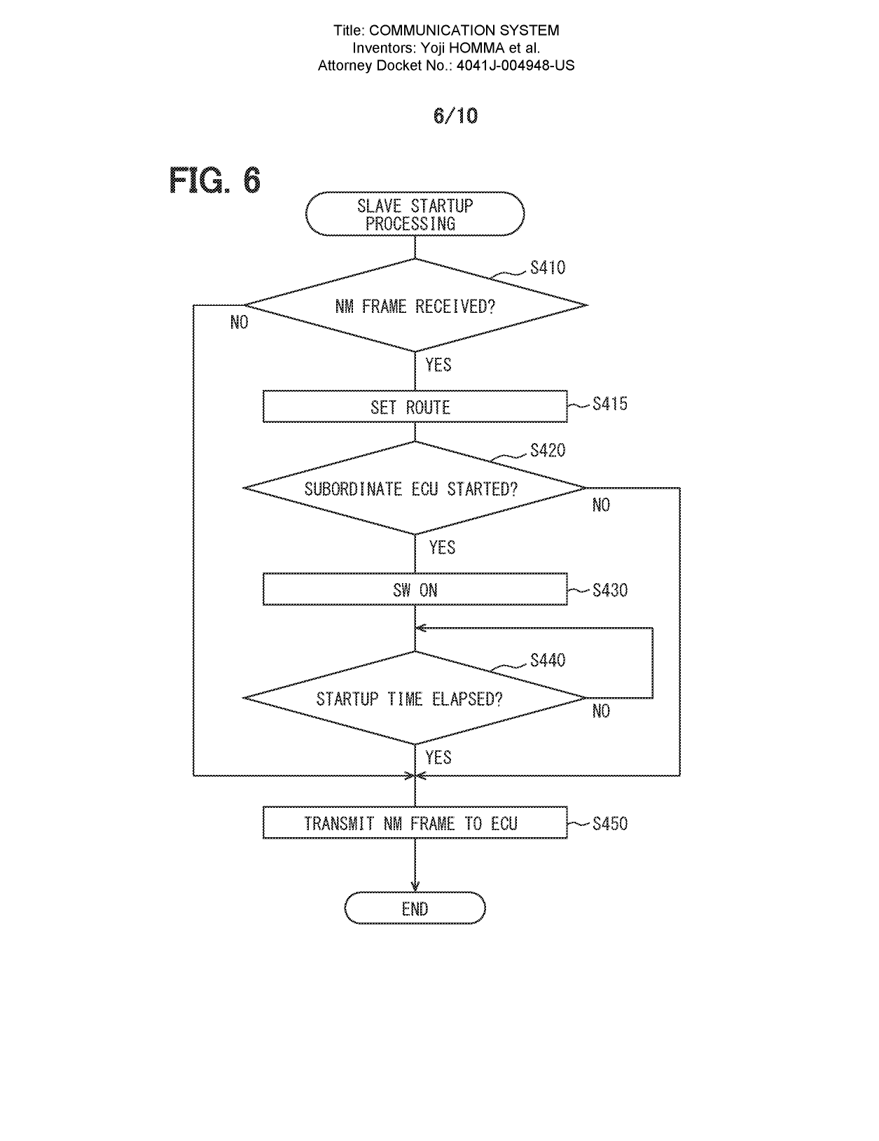

Next, FIG. 6 is a flowchart illustrating the slave activation processing for activating the slave ECUs 6 to 11, executed by the CPUs 71, 91, and 111 of the plurality of control ECUs 3, 4, and 5 (hereinafter, subordinate CPUs 71, etc.). The slave activation processing is a process that starts, for example, when the power supply to the control ECUs 3, 4, and 5 is turned on.

In the slave activation processing, as shown in FIG. 6, first, at S410, the subordinate CPUs 71, etc. determine whether an NM frame has been received. The NM frame here may include the setting notification and activation command transmitted by the management ECU 2.

Subsequently, at S415, the subordinate CPUs 71, etc. set the system to perform communication via the new communication path according to the setting notification. The subordinate CPUs 71, etc. also store the new communication path and the previous communication path in the storage units 64, 84, and 104. These new and previous communication paths are configured to be readable from the storage units 64, 84, and 104 when the subordinate CPUs 71, etc. are rebooted.

Subsequently, at S420, the subordinate CPUs 71, etc. determine whether to activate the subordinate ECUs according to the activation command included in the NM frame. The subordinate ECUs refer to the slave ECUs 6 to 11 subordinate to the control ECUs 3, 4, and 5; slave ECUs 6 and 7 are subordinate to control ECU 3, slave ECUs 8 and 9 are subordinate to control ECU 4, and slave ECUs 10 and 11 are subordinate to control ECU 5. Note that the control ECUs 3, 4, and 5 may also be considered subordinate ECUs from the perspective of the management ECU 2.

At S420, for example, in the case of control ECU 4, if there is no need to activate the subordinate ECUs and the NM frame is simply relayed, a negative determination is made; in the case of control ECU 3, if the slave ECU 6 is to be activated, a positive determination is made. If the subordinate ECU is not activated, the process proceeds to S450. If the subordinate ECU is activated, the process proceeds to S430.

Subsequently, at S430, the subordinate CPUs 71, etc. set the power distribution switch corresponding to the subordinate ECU to the on state. As a result, power is supplied to the subordinate ECU, and the ECU is activated. For example, when control ECU 3 turns on the power supply to the slave ECU 6 (i.e., supplies power), it sets the power distribution switch 65 to the on state.

Subsequently, at S440, the subordinate CPUs 71, etc. determine whether the activation time has elapsed. The activation time is the time from when the power supply to the subordinate ECU is turned on until activation is completed. The activation time is generally the same as the diagnostic mask time. If the activation time has not elapsed, S440 is repeated. If the activation time has elapsed, the process proceeds to S450.

Subsequently, at S450, the subordinate CPUs 71, etc. transmit the NM frame to the next control ECU in the relay path or to the subordinate ECU. The NM frame transmitted here may include, as with the NM frame received from the management ECU 2, a setting notification and an activation command. However, when transmitting the NM frame to a subordinate ECU that has already been activated, the activation command is unnecessary. When this processing is completed, the present processing ends. Note that the NM frame may include not only the activation command but also stop information described later, or a command for waking up or putting the ECU into sleep mode. If the subordinate ECU is in a sleep state, in S430 described above, the control ECUs 3, 4, and 5 may transmit a wake-up command to the subordinate ECU. If the subordinate ECU is configured to recognize the NM frame even in the sleep state, the transmission of the wake-up command from the control ECUs 3, 4, and 5 may be omitted. Alternatively, the subordinate ECU may receive the NM frame transmitted at S450 and wake itself up.

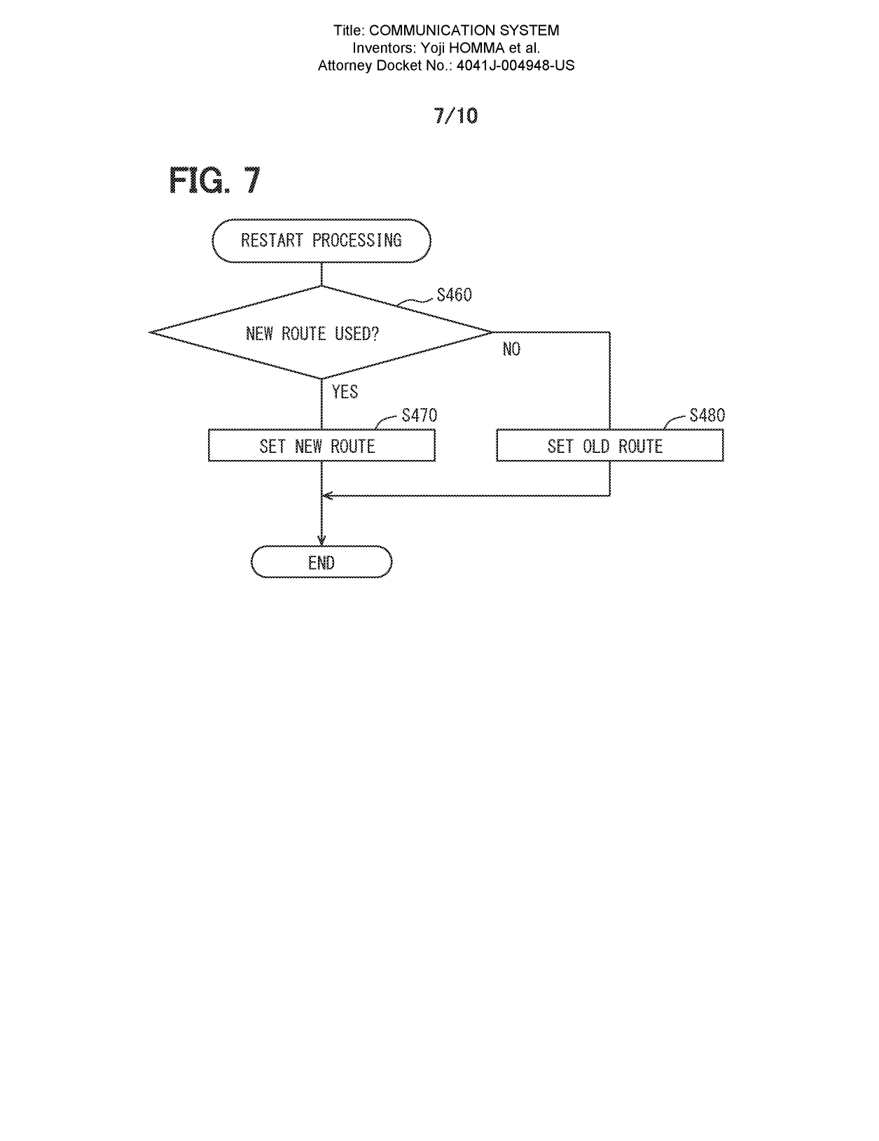

Next, FIG. 7 is a flowchart illustrating the reboot processing. The reboot processing is a process that is started, for example, when the management ECU 2 enters sleep or power-off due to ignition off or the like after a change in the communication path, and is subsequently restarted; this process is executed by the CPU 51 of the management ECU 2.

Subsequently, at S460, the CPU 51 of the management ECU 2 determines whether it is set to use the new communication path. Here, when the management ECU 2 is restarted after a communication interruption is detected, it is preset whether communication is to be performed using the new communication path or the previous communication path (i.e., the communication path before the communication interruption). This setting can be changed arbitrarily, and is shared with each device constituting the network using an NM frame or the like. If the new communication path is to be used, the process proceeds to S470; if the previous communication path is to be used, the process proceeds to S480.

Subsequently, at S470, the CPU 51 of the management ECU 2 sets the system to use the new communication path. In this case, communication is resumed via the new communication path without using the previous communication path.

On the other hand, at S480, the CPU 51 of the management ECU 2 sets the system to use the previous communication path. In this case, if a communication interruption is detected again during the master activation processing described above, the new communication path will be used. When these processes are completed, the reboot processing ends. Whether to use the new communication path or the previous communication path is notified to each device by the setting notification in the NM frame.

Next, as (B) the process for stopping a slave ECU, the process for stopping the slave ECU 6 will be described. Note that the process described below is not limited to stopping the slave ECU 6, but can also be applied to, for example, putting the slave ECU 6 or the like into sleep mode, where it is necessary to consider a waiting time, and to processes for transmitting an NM frame to a specified communication partner.

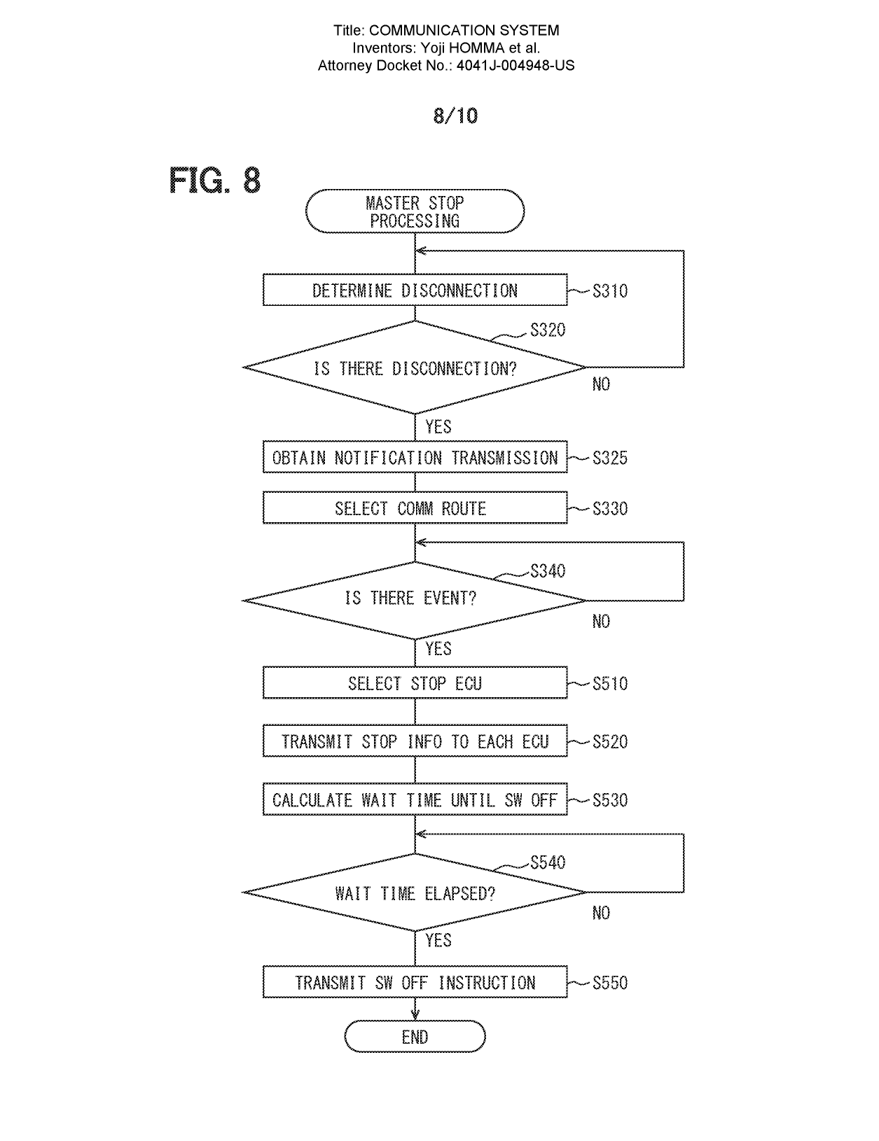

FIG. 8 is a flowchart illustrating the master stop processing. The master stop processing is a process that is started, for example, when the management ECU 2 is activated, and is executed by the CPU 51 of the management ECU 2.

Steps S310 to S340 in the master stop processing are the same as steps S310 to S340 in the master activation processing. As shown in FIG. 8, when an event occurs at S340, the process proceeds to S510.

Subsequently, at S510, the CPU 51 of the management ECU 2 selects the ECU to be stopped according to the event. In one example of this embodiment, the slave ECU 6 is selected. Subsequently, at S520, the CPU 51 of the management ECU 2 transmits an NM frame to the new communication path. This NM frame includes stop information for stopping the slave ECU 6 and the aforementioned setting notification. The stop information is sequentially transmitted along the new communication path.

Subsequently, at S530, the CPU 51 of the management ECU 2 calculates the waiting time until SW OFF (i.e., SW OFF time or off waiting time). The waiting time until SW OFF is the time required for the shutdown sequence of the slave ECU 6 to be completed and for the power distribution switch 65 to be turned off. This time is set in consideration of the time required for the slave ECU 6 to complete the shutdown sequence after receiving the stop information. The time until the slave ECU 6 is shut down is known in advance.

Subsequently, at S540, the CPU 51 of the management ECU 2 determines whether the waiting time has elapsed since the waiting time was set. If the waiting time has not elapsed, S540 is repeated. If the waiting time has elapsed, the process proceeds to S550.

Subsequently, at S550, the CPU 51 of the management ECU 2 transmits an NM frame to perform processing related to the slave ECU 6. Specifically, this is an NM frame including an SW OFF command, which is an instruction to set the power distribution switch 65 to the off state in order to stop the power supply to the slave ECU 6. This NM frame is sequentially transmitted along the new communication path. When this processing is completed, the master stop processing ends.

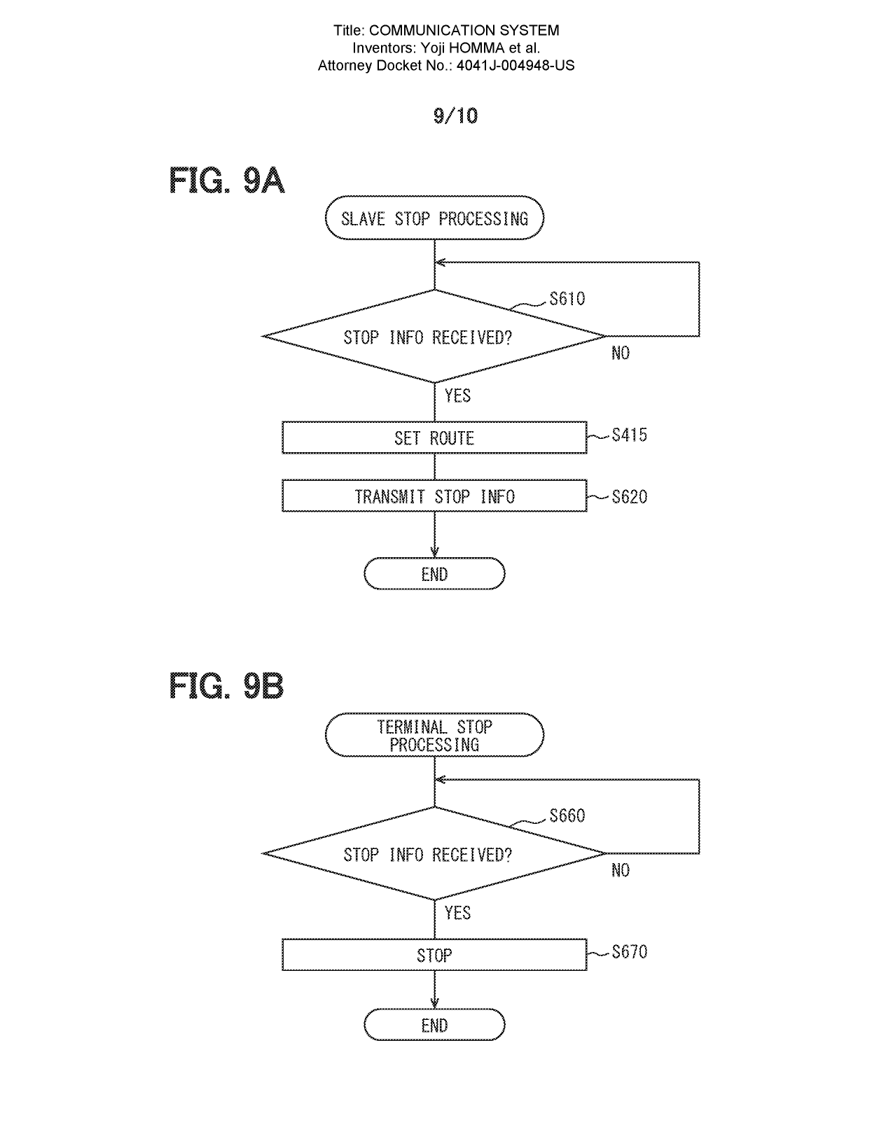

Next, FIG. 9A is a flowchart illustrating the slave stop processing for stopping the slave ECU 6, executed by the subordinate CPUs 71, etc. The slave stop processing is a process that starts, for example, when the power supply to the subordinate CPUs 71, etc. is turned on. In addition, the slave stop processing is executed, for example, by the control ECUs 3 and 4 when a communication interruption is detected on communication line 31 and communication is performed in the order of communication line 32, control ECU 4, communication line 34, control ECU 3, and communication bus 36.

In the slave stop processing, as shown in FIG. 9A, first, at S610, the subordinate CPUs 71, etc. determine whether an NM frame has been received. Here, in particular, it is determined whether stop information has been received. Note that the NM frame includes the setting notification transmitted by the management ECU 2. If the NM frame has not been received, S610 is repeated. If the NM frame has been received, the process proceeds to S415.

Subsequently, at S415, the subordinate CPUs 71, etc. set the system to perform communication via the new communication path according to the setting notification. Subsequently, at S620, the subordinate CPUs 71, etc. relay the NM frame including the received stop information along the new communication path. For example, the control ECU 4 relays the NM frame to the control ECU 3, and the control ECU 3 relays the NM frame to the slave ECU 6. When this processing is completed, the present processing ends.

Next, FIG. 9B is a flowchart illustrating the terminal stop processing executed by the CPUs (not shown) of the slave ECUs 6 to 11. The terminal stop processing is a process that starts, for example, when the power supply to the slave ECUs 6 to 11 is turned on.

In the terminal stop processing, as shown in FIG. 9B, first, at S660, the slave ECUs 6 to 11 determine whether an NM frame has been received. Here, in particular, it is determined whether stop information has been received. If the NM frame has not been received, S660 is repeated. If the NM frame has been received, the process proceeds to S670.

Subsequently, at S670, the slave ECUs 6 to 11 perform processing to stop their own device in accordance with the received stop information. That is, a shutdown is executed. When this processing is completed, the present processing ends. Note that the processing for stopping the device is not limited to shutdown and may also be a sleep process. Sleep is a state in which at least the transmission of frames is stopped, and the power consumption is lower than in the normal state (for example, the state in which frames can be transmitted). Further, the NM frame including the stop information may be transmitted by the management ECU 2 or by the control ECUs 3, 4, and 5.

### 2-5. Effects

According to the second embodiment described in detail above, the effects (1a) of the first embodiment described above are achieved, and further, the following effects are obtained.

(2a) The vehicle control system 1 is a system in which the management ECU 2 and a plurality of control ECUs 3, 4, and 5 managed by the management ECU 2 are each configured to be capable of communicating with each other by selectively using one of a plurality of communication paths. Each device is connected, for example, in a ring configuration by communication lines 31 to 35.

The CPU 51 of the management ECU 2 is configured, at S330, to select a new communication path avoiding the abnormal section when an abnormality notification indicating a notification capable of specifying the abnormal section, which is the section where an abnormality has occurred in the communication path used before abnormality detection, is received. The CPU 51 of the management ECU 2 is configured, at S360, to transmit a setting notification, which is a notification indicating that communication is to be performed using the selected new communication path, to at least the plurality of control ECUs 3, 4, and 5.

The CPU 51 of the management ECU 2 is configured, at S310, to detect an abnormality in the communication path. The CPU 51 of the management ECU 2 is configured, at S325, to notify the detected abnormality within the management ECU 2.

The CPUs 71, 91, and 111 of the plurality of control ECUs 3, 4, and 5 are configured, at S415, to set the new communication path and perform communication according to the setting notification. With such a configuration, when an abnormality occurs in a communication path, a new communication path avoiding the abnormal section can be established, and communication can be performed using this new communication path, thereby making it less likely that necessary communication cannot be performed.

(2b) The vehicle control system 1 further includes slave ECUs 6 to 11, which are devices communicably connected to at least one of the plurality of control ECUs 3, 4, and 5. The management ECU 2 is configured, at S370 and S530, to calculate the processing wait time (for example, diagnostic mask time, SW OFF time) for itself or the plurality of control ECUs 3, 4, and 5, taking into account the required waiting time related to the slave ECUs 6 to 11. The required waiting time includes, for example, the communication delay time from the synchronization time, the ECU activation time, and the power-off time.

Further, at S450 and S550, the management ECU 2 and at least one of the plurality of control ECUs 3, 4, and 5 are configured to perform processing related to the target device after waiting for the processing wait time.

Specifically, at S380, the CPU 51 of the management ECU 2 is configured to notify at least the plurality of control ECUs 3, 4, and 5 of the processing wait time. Further, at S550, the CPU 51 of the management ECU 2 is configured to transmit a control instruction (for example, an NM frame) to at least the plurality of control ECUs 3, 4, and 5 after waiting for the processing wait time.

With such a configuration, the management ECU 2 or the plurality of control ECUs 3, 4, and 5 can calculate the processing wait time in consideration of the required waiting time, and perform processing after waiting for the processing wait time.

(2c) In the vehicle control system 1, the management ECU 2, the plurality of control ECUs 3, 4, and 5, and the slave ECUs 6 to 11 may be configured to perform time synchronization for communication. At S370 and S530, the CPU 51 of the management ECU 2 is configured to calculate, as the processing wait time, the communication delay time accompanying a change in the communication path, taking into account the required communication time to the target device as the required waiting time.

With such a configuration, even if the communication delay time increases, it is possible to correct the synchronization time and set the processing timing in consideration of the increase.

(2d) In the vehicle control system 1, the management ECU 2 includes a storage unit 43 configured to store the new communication path and the previous communication path before the new communication path is set. When the management ECU 2 is rebooted, it is configured to start communication using the previous communication path.

With such a configuration, when the management ECU 2 is rebooted, communication can be performed using the previous communication path as usual. This is effective in cases where the abnormality in the communication path is restored by rebooting the management ECU 2.

(2e) In the vehicle control system 1, the management ECU 2 may also include a storage unit 43 configured to store the new communication path and the previous communication path before the new communication path is set. When the management ECU 2 is rebooted, it may start communication using the new communication path.

With such a configuration, when the management ECU 2 is rebooted, communication can be performed using the new communication path. This is effective in cases where, for example, there is physical damage to the communication path and the situation is not improved even if the management ECU 2 is rebooted.

(2f) In the vehicle control system 1, at S360, the CPU 51 of the management ECU 2 is configured to transmit an activation command for activating the target device along the new communication path. At S370 and S530, the CPU 51 of the management ECU 2 is configured to calculate, as the processing wait time, the diagnostic mask time for the target device, taking into account the activation time of the target device as the required waiting time.

With such a configuration, it is possible to suppress the erroneous determination that the target device is abnormal during the period from activation of the target device until it operates normally. That is, it is possible to suppress erroneous diagnostics from being stored in each device.

### 3. Other Embodiments

The embodiments of the present disclosure have been described above, but the present disclosure is not limited to the above embodiments and may be implemented in various modified forms.

(3a) In the second embodiment described above, the management ECU 2 is provided with a configuration for detecting abnormalities in the communication path, but this is not limiting. For example, at least one of the plurality of control ECUs 3, 4, and 5 may be provided with such a configuration.

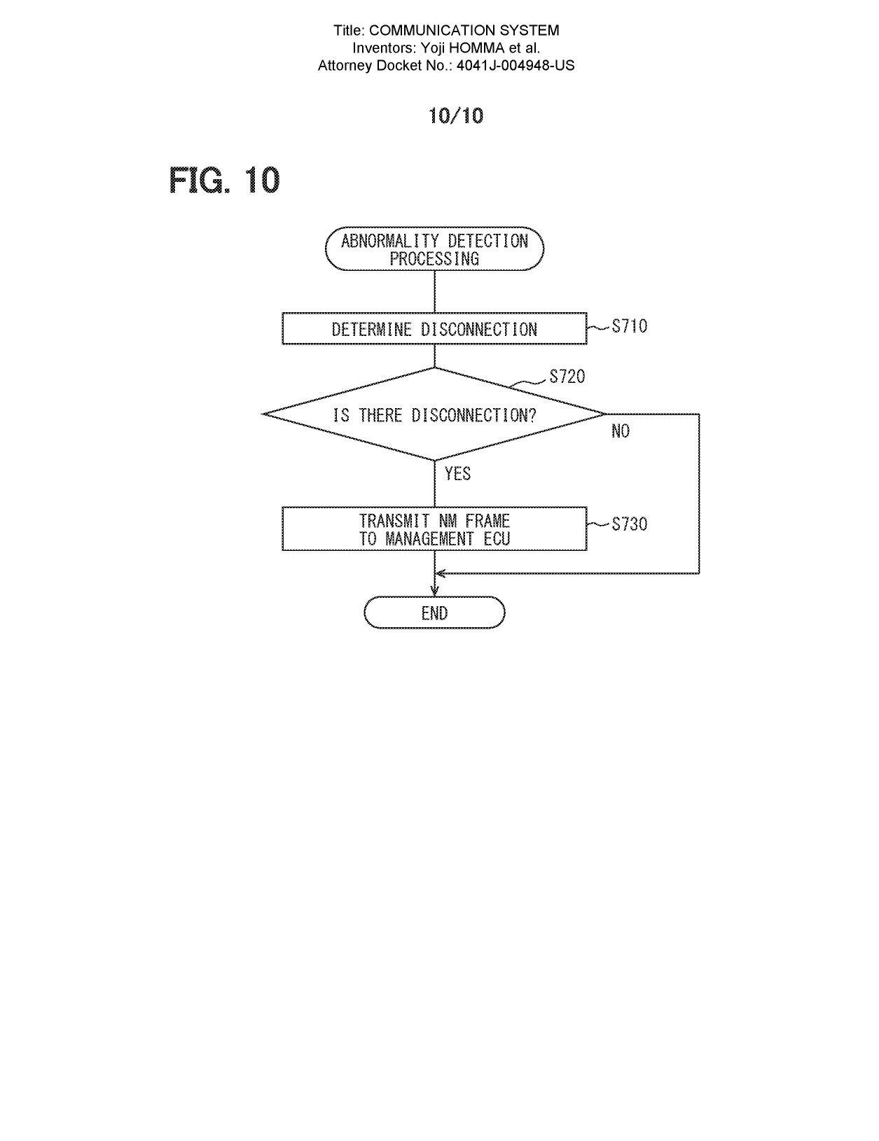

When the control ECUs 3, 4, and 5 detect abnormalities in the communication path, for example, the processing shown in FIG. 10 is executed. FIG. 10 is a flowchart illustrating the slave detection processing executed by the subordinate CPUs 71, etc. The abnormality detection processing is a process that starts, for example, when the power supply to the control ECUs 3, 4, and 5 is turned on.

In the abnormality detection processing, as shown in FIG. 10, first, at S420, the subordinate CPUs 71, etc. perform a disconnection determination. This process is the same as S230 and S310 described above. Subsequently, at S720, the subordinate CPUs 71, etc. determine whether a communication interruption has occurred. This process is the same as S320 described above. If there is no communication interruption, the process returns to S710. If there is a communication interruption, the process proceeds to S730.

At S730, the subordinate CPUs 71, etc. transmit an NM frame to the management ECU 2. The NM frame here includes an abnormality notification. When an abnormality in the communication path is detected and the control ECUs 3 to 5 notify the management ECU 2 of the abnormality, for example, broadcast may be used. This is because the control ECUs 3 to 5 may not be aware of the network configuration (i.e., how each device is connected). However, if the control ECUs 3 to 5 are aware of the network configuration, the abnormality notification may be performed using a communication path capable of communicating with the management ECU 2. When this processing is completed, the present processing ends.

When an abnormality notification is transmitted in this process, the management ECU 2 executes the processing from S325 onward in the master activation processing and master stop processing, and may acquire the abnormality notification transmitted by the subordinate CPUs 71, etc. in the processing at S325.

(3b) In the above second embodiment, the configuration is such that the communication path is changed immediately upon abnormality detection, but this is not limiting. For example, it is also possible not to change the communication path unless a predetermined condition is satisfied, such as when a preset event occurs at the time of abnormality detection. In this case, when the vehicle power supply is cut off and then reapplied (for example, when the ignition is turned on), communication may be performed using the new communication path.

(3c) In the above second embodiment, S360 describes an example in which only the slave ECU 6 is activated as the target device, but if the control ECUs 3, 4, and 5 are in a sleep state, the control ECUs 3, 4, and 5 may be activated as the target devices. In such a case, the CPU 51 of the management ECU 2 may transmit activation commands sequentially to the plurality of target devices in the order of connection from the starting point to the end point along the new communication path. For example, when the management ECU 2 activates the slave ECU 10 while the control ECU 5 and slave ECUs 10 and 11 are in a sleep state, the CPU 51 of the management ECU 2 may first activate the control ECU 5 and then activate the slave ECU 10.

With such a configuration, it is possible to sequentially activate each of the plurality of target devices in consideration of the connection order.

(3d) The control units 41, 61, 81, and 101 and their methods described in the present disclosure may be implemented by a dedicated computer provided by configuring a processor and memory programmed to execute one or more functions embodied as a computer program. Alternatively, the control units 41, 61, 81, and 101 and their methods described in the present disclosure may be implemented by a dedicated computer provided by configuring a processor using one or more dedicated hardware logic circuits. Alternatively, the control units 41, 61, 81, and 101 and their methods described in the present disclosure may be implemented by one or more dedicated computers configured by a combination of a processor and memory programmed to execute one or more functions and a processor configured by one or more hardware logic circuits. Further, the computer program may be stored as instructions executable by a computer on a computer-readable non-transitory tangible recording medium. The method for realizing the functions of each part included in the control units 41, 61, 81, and 101 does not necessarily have to include software, and all functions may be realized using one or more hardware components.

(3e) The plurality of functions possessed by one component in the above embodiments may be realized by a plurality of components, or one function possessed by one component may be realized by a plurality of components. Further, a plurality of functions possessed by a plurality of components may be realized by one component, or one function realized by a plurality of components may be realized by one component. In addition, a part of the configuration of the above embodiments may be omitted. Furthermore, at least a part of the configuration of the above embodiments may be added to or replaced with the configuration of another embodiment described above.

(3f) In addition to the ECUs 2 to 5 described above, the present disclosure may also be realized in various forms such as a system including the ECUs 2 to 5 as components, a program for causing a computer to function as the ECUs 2 to 5, a non-transitory tangible recording medium such as a semiconductor memory storing this program, and a communication control method.

What is claimed is:

1. A communication system comprising:
a management device;
a plurality of managed devices managed by the management device; and
at least one target device, which is a device communicably connected to at least one of the plurality of managed devices,
wherein
each of the management device, the plurality of managed devices, and the at least one target device is configured to communicate with each other by selectively using one of a plurality of communication paths,
the management device includes:
a communication path selection unit configured to select a new communication path avoiding an abnormal section when an abnormality notification indicating a notification capable of specifying the abnormal section, which is a section where an abnormality has occurred among the plurality of communication paths, is received; and
a notification transmission unit configured to transmit a setting notification, which is a notification indicating that communication is to be performed using the selected new communication path, to at least the plurality of managed devices,
at least one of the management device and the plurality of managed devices includes:
an abnormality detection unit configured to detect an abnormality in the communication path; and
an abnormality notification unit configured to notify the communication path selection unit of the abnormality notification regarding the detected abnormality,
the plurality of managed devices includes:
a path change unit configured to set the new communication path and perform communication according to the setting notification, and
the setting notification includes switching information capable of identifying whether to set the plurality of managed devices and/or the target device to an on state or an off state.

2. The communication system according to claim 1, wherein
the management device further includes a time calculation unit configured to calculate a processing wait time for the management device or the plurality of managed devices, taking into account a required waiting time related to the target device, and
at least one of the management device and the plurality of managed devices further includes a processing execution unit configured to perform processing related to the target device after waiting for the processing wait time.

3. The communication system according to claim 1, wherein
the management device further includes a time calculation unit configured to calculate a processing wait time for the management device or the plurality of managed devices, taking into account a communication delay time accompanying a change in the communication path, and
at least one of the management device and the plurality of managed devices further includes a processing execution unit configured to perform processing related to the target device after waiting for the processing wait time.

4. The communication system according to claim 1, wherein
the management device, the plurality of managed devices, and the target device are configured to perform time synchronization for communication, and
at least one of the management device and the plurality of managed devices is configured to correct synchronization time with other devices, taking into account a communication delay time accompanying a change in the communication path.

5. The communication system according to claim 1, wherein
the management device includes a storage unit configured to store the new communication path and a previous communication path before the new communication path is set, and
the management device is configured to start communication using the previous communication path when the management device is rebooted.

6. The communication system according to claim 1, wherein
the management device includes a storage unit configured to store the new communication path and a previous communication path before the new communication path is set, and
the management device is configured to start communication using the new communication path when the management device is rebooted.

7. The communication system according to claim 2, wherein
the time calculation unit is configured to calculate, as the processing wait time, a diagnostic mask time for the target device.

8. The communication system according to claim 2, further comprising
a power distribution switch that switches a power supply of the target device between an on state and an off state,
wherein
the time calculation unit is configured to calculate, as the processing wait time, an off waiting time until the power distribution switch transitions from the on state to the off state.

9. The communication system according to claim 1, wherein
the at least one target device includes a plurality of target devices,
the management device further includes an activation transmission unit configured to transmit an activation command for activating the target devices along the new communication path, and
the activation transmission unit is configured to transmit the activation command sequentially to the plurality of target devices in accordance with a connection order of the plurality of target devices from a starting point to an end point in the new communication path, starting from the target device closer to the starting point.
